(19) United States
(12) Patent Application Publication
(10) Pub. No.: US 2004/0008976 A1
(43) Pub. Date: Jan. 15, 2004

(54) Portable image playback apparatus, method of controlling operation of same, portable image pick-up apparatus and method of controlling operation of same

(75) Inventors: Mikio Sasagawa, Asaka-shi (JP); Masafumi Hirata, Asaka-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD., Minami-Ashigara-shi (JP)

(21) Appl. No.: 10/407,235

(22) Filed: Apr. 7, 2003

Related U.S. Application Data
(63) Continuation of application No. 09/801,735, filed on Mar. 9, 2001, now abandoned.

(30) Foreign Application Priority Data
Mar. 9, 2000 (JP) 2000-64252

(51) Int. Cl. H04N 5/76; H04N 5/225

(52) U.S. Cl. 386/96; 386/117

(57) ABSTRACT

Recording and playback of images and music independently of each other is made possible. To achieve this, it is so arranged that still-picture files, moving-picture files and music files can be recorded on a memory card. If a file selected from among files read out of the memory card is a still-picture file or a moving-picture file, an image represented by the read file is displayed on a liquid crystal display device and supply of voltage to circuits for music playback is cut off. If a selected file is a music file, then supply of voltage to circuits for image playback is cut off and music is played back.

### BACKGROUND OF THE INVENTION

1. Field of the Invention

This invention relates to a portable image playback apparatus for reproducing image data that has been recorded on a recording medium, a method of controlling the operation of this apparatus, a portable image pickup apparatus for recording image data on a recording medium, and a method of controlling the operation of this apparatus.

2. Description of the Related Art

Movie video cameras and the like can used to record simultaneously the moving picture and sound of a subject. However, no thought has been given to the recording of a moving picture and the recording of sound separately and independently of each other using such a camera. As a consequence, even when a moving picture and sound are to be recorded separately, the circuits for recording the moving picture and the circuit for recording sound operate together. The same is true at playback.

### DISCLOSURE OF THE INVENTION

Accordingly, an object of the present invention is to perform playback of an image such as a moving picture and playback of sound separately and independently.

Another object of the present invention is to make it possible to record images and sound in linkage with each other.

A portable image playback apparatus according to the present invention comprises: a data reading unit for reading data that has been recorded on a recording medium capable of recording both image data representing an image and audio data representing audio; an image playback processing unit for subjecting image data, which has been read by the data reading unit, to image playback processing; a first display controller for controlling a display unit so as to display an image represented by the image data that has been subjected to image playback processing by the image playback processing unit; an audio playback processing unit for subjecting audio data, which has been read by the data reading unit, to audio playback processing; and an audio output unit for outputting audio, which is represented by the audio data that has been subjected to audio playback processing by the audio playback processing unit, independently of display of an image on the display unit (which includes performing image display and audio output without relation to each other, performing image display or audio output, and performing mutually related image display and audio output simultaneously).

The present invention provides also a method of controlling the operation of the apparatus described above. Specifically, the invention comprises the steps of: reading data that has been recorded on a recording medium capable of recording both image data representing an image and audio data representing audio; subjecting read image data to image playback processing; displaying on a display unit an image represented by the image data that has been subjected to image playback processing; subjecting read audio data to audio playback processing; and outputting audio, which is represented by the audio data that has been subjected to audio playback processing, independently of display of an image on the display unit.

In accordance with the present invention, data that has been recorded on a recording medium capable of recording both image data and audio data is read. If the read data is image data, image playback processing is applied and an image represented by the read image data is displayed on a display unit. If the read data is audio data, audio playback processing is applied and audio represented by the read audio data is output.

Display of an image and output of audio can be performed simultaneously even if the image and audio are entirely unrelated. Of course, it is possible also to display an image and to output audio that are related to each other. It goes without saying that it is also possible to present an image display only or to provide an audio output only.

An arrangement may be adopted in which it is determined whether read data is image data or audio data, image data that has been read is subjected to image playback processing in accordance with a determination that the read data is image data, and audio data that has been is subjected to audio playback processing in accordance with a determination that the read data is audio data.

Thus, it becomes possible to adopt an arrangement in which an image is displayed or audio is output, without specifying image display or audio output, depending upon whether read data is image data or audio data.

A mode setting device may be provided for selectively setting either an image playback mode or an audio playback mode. In such case it would be determined whether read data is image data or audio data in accordance with the set mode.

In a case where image identification data is linked with the image data in order to identify that this data is image data and audio identification data is linked with the audio data in order to identify that this data is audio data, whether read data is image data or audio data may be determined on the basis of the image identification data or audio identification data.

When the recording medium includes a header recording area and a data recording area, image data and audio data have been recorded in the data recording area, and identification data indicating whether data that has been recorded in a prescribed area of the data recording area is image data or audio data has been recorded in the header recording area, whether the read data is image data or audio data can be determined based upon the identification data that has been recorded in the header recording area.

The apparatus may further comprise an image sensing unit for sensing the image of a subject and outputting image data representing the image of the subject, and a recording controller for recording image data, which has been output from the image sensing unit, on the recording medium.

The apparatus may further comprise a mode command switch for selectively applying an image playback mode command or an audio playback mode command, and a power-source controller for turning on a power source in response to application of the image playback mode command or audio playback mode command by the mode command switch.

The image playback mode or audio playback mode can be set in accordance with the mode command from the mode command switch. Since the power source is turned on merely by selecting the mode, the user need not take the trouble to turn on a power switch.

The apparatus may further comprise: a power switch; a power-source control unit for turning on a power source in response to the power switch being turned on; a mode command switch for selectively applying an image playback mode command or an audio playback mode command; and a power supply unit for starting supply of power to the image playback processing unit and display controller in accordance with application of the image playback mode command by the mode command switch, and starting supply of power to the audio playback processing unit and audio output unit in accordance with application of the audio playback mode command by the mode command switch.

It is possible to selectively set either the image playback mode or audio playback mode, and it is possible to display the name of a file that stores data corresponding to the mode set by the mode setting unit, this data being part of the data that has been read.

This makes it possible to ascertain the image that can be displayed or the audio that can be output in the currently set mode.

Whether read items of image data and audio data are linked to each other may be determined and the image display unit and audio output unit may be controlled, in accordance with a determination that the image data and audio data have been linked to each other, so as to output audio represented by the read audio data during display of an image represented by the read image data.

Thus, while an image is being displayed, audio linked with this image can be output.

The apparatus preferably is further provided with a data detection unit for detecting mutually linked image data and audio data in data that has been read by the data reading unit, and a third display controller for controlling the display unit in such a manner that the names of files storing data detected by the data detection unit will be displayed in a manner distinguishable from the names of other files.

Thus, with which file a particular file is linked can be ascertained at a glance.

Preferably, images represented by read image data are displayed on the display unit, and an image represented by image data, which is linked with other image data or with audio data, in image data representing an array of displayed images is displayed in a manner distinguishable from other images.

Thus, whether image data or audio data linked with an image being displayed exists or not can be ascertained at a glance.

Preferably, the display controller or audio output controller is controlled, in accordance with selection of an image represented by the linked image data, so as to display an image or output audio represented by other image data or by audio data that is linked with the linked image data.

A portable image pick-up apparatus according to another aspect of the present invention comprises: an image sensing unit for sensing the image of a subject and outputting image data representing the image of the subject; an audio-data input unit for inputting audio data; a selection unit for selecting, from image data output by the image sensing unit and audio data input by the audio-data input unit, image data and audio data to be linked with each other; and a recording controller for recording the image data and the audio data selected by the selection unit on a recording medium in a form linked with each other.

The present invention provides also a method of controlling the operation of the apparatus described above. Specifically, the invention comprises the steps of: sensing the image of a subject and obtaining image data representing the image of the subject; inputting audio data; selecting, from image data obtained by image sensing and input audio data, image data and audio data to be linked with each other; and recording the selected image data and audio data on a recording medium in a form linked with each other.

In accordance with the present invention, image data and audio data to be linked to each other can be selected and the selected image data and audio data can be recorded on a recording medium in a form linked to each other. Desired image data and audio data can be recorded on a recording medium in any combination in a form linked to each other.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a perspective view illustrating a digital camera as seen from the front side thereof;

FIG. 2 is a perspective view illustrating the digital camera as seen from the back side thereof;

FIG. 3 is a block diagram showing the electrical construction of the digital camera;

FIG. 4 is a diagram showing the data structure of a memory card;

FIG. 5 is a flowchart illustrating processing for setting a still-picture recording mode;

FIG. 6 is a perspective view illustrating a digital camera as seen from the back side thereof;

FIG. 7 is a flowchart illustrating processing for setting a still-picture recording mode with the digital camera of FIG. 6;

FIG. 8 is a flowchart illustrating the processing for a playback mode;

FIG. 9 is a diagram illustrating an example of a display screen of a liquid crystal display device;

FIG. 10 is a perspective view illustrating a digital camera as seen from the back side thereof;

FIG. 11 is a flowchart illustrating the processing for a playback mode with the digital camera of FIG. 10;

FIG. 12 is a diagram illustrating an example of a display screen of the liquid crystal display device;

FIG. 13 is a flowchart illustrating file linkage processing;

FIG. 14 is a diagram illustrating an example of a display screen of the liquid crystal display device when linking of files is performed; and

FIG. 15 is a diagram showing another example of the data structure of a memory card.

### DESCRIPTION OF THE PREFERRED EMBODIMENTS

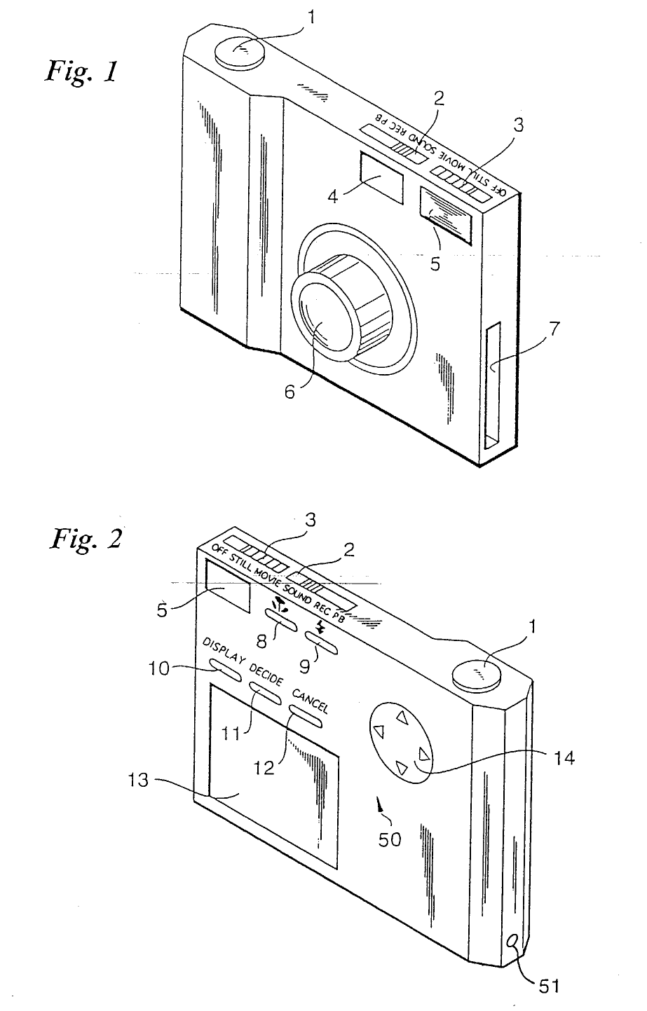

FIG. 1, which illustrates an embodiment of the present invention, is a perspective view of a digital camera as seen from the front side thereof. The digital camera has a still-picture taking function, a moving-picture taking function, an audio recording function, a still-picture playback function, a moving-picture playback function and an audio playback function.

The top side of the digital camera is provided with a shutter-release button 1 on the left side thereof as seen from the front of the camera. Also provided on the top right side are a recording/playback mode switch 2 for setting a recording mode or a playback mode, and a mode switch 3 for turning off a power source and setting still-picture recording or playback, moving-picture recording or playback or audio recording and playback.

An imaging lens 6 is provided on the front side of the digital camera approximately at the center thereof. An optical viewfinder 5 is provided on the front side of the camera at the upper right thereof. A strobe electronic flash 4 is provided at the left side of the optical viewfinder 5. The right side of the digital camera is formed to have a memory-card insertion opening 7.

FIG. 2 is a perspective view showing the digital camera as seen from the back side thereof.

The back side of the digital camera is provided with a liquid crystal display screen 13 at the lower left. Provided above the liquid crystal display screen 13 are a display switch 10 for turning the liquid crystal display screen 13 on and off, a decide switch 11 for applying a decision command, and a cancel switch 12. Provided at the upper right of the liquid crystal display screen 13 is an up, down, left, right button 14 on which arrows pointing up, down, left and right are formed. Each arrow formed on the up, down, left, right button 14 can be pressed.

A macro mode setting switch 8 and a light-emission switch 9 for applying a strobe-flash command are provided on the back side of the digital camera on its upper part.

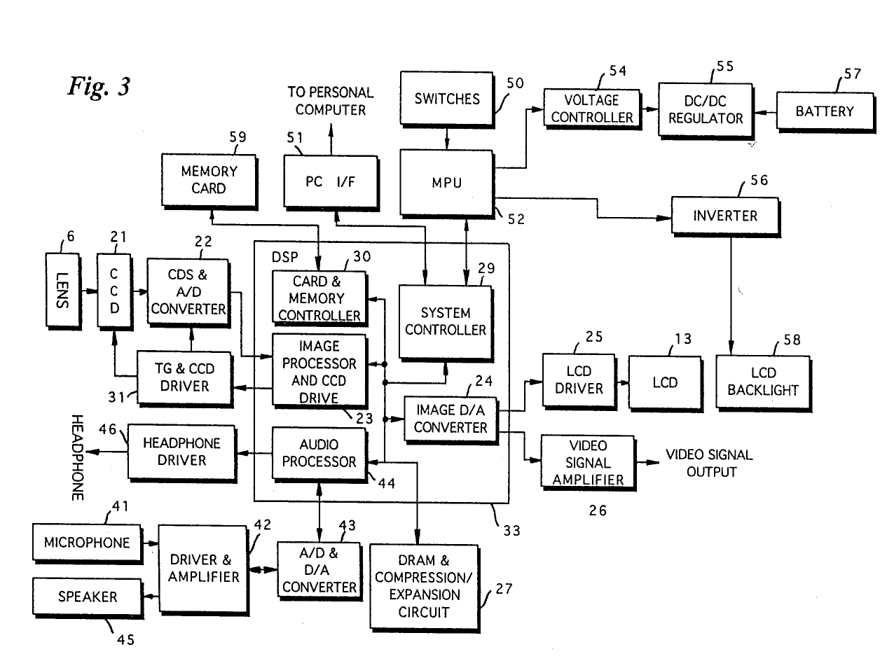

FIG. 3 is a block diagram illustrating the electrical construction of the digital camera.

The overall operation of the digital camera is controlled by a system control circuit 29.

Various command signals provided by the above-mentioned switches (the shutter-release button 1, mode switches 2, 3, switches 8, 9, 10, 11, 12 and up, down, left, right button 14) are input to the system control circuit 29 via an MPU (microprocessing unit) 52.

Voltage provided by a battery 57 is applied to each circuit from a DC/DC regulator 55 controlled by a voltage control circuit 54. A backlight 58 for the liquid-crystal display device is turned on and off and its luminance level adjusted by an inverter 56. The voltage control circuit 54 and the inverter 56 are controlled by the MPU 52.

The camera includes a TG (timing generator) and a CCD driver 31. The TG & CCD driver 31 output various control pulses that enter a CCD 21 and a CDS (correlated double sampling circuit) and A/D converting circuit 22.

The image of a subject is formed on the photoreceptor surface of the CCD 21 by the imaging lens 6. The CCD 21 outputs a video signal representing the image of the subject, and the video signal enters the CDS & A/D converter 22. The latter performs correlated double sampling, executes analog/digital conversion processing and outputs digital image data. The digital image data is applied to an image processing and CCD driving circuit 23 within a DSP (digital signal processing circuit) 33, where the data is subjected to prescribed image processing such as a color balance adjustment and a gamma correction.

The digital image data is applied to an image D/A converting circuit 24, where the data is restored to an analog video signal. The analog video signal is then applied to a liquid crystal display device 13 via a liquid crystal driver 25, whereby the captured image of the subject is displayed as a moving picture.

The digital camera according to this embodiment is also capable of outputting a video signal. A video signal amplifier circuit 26 is provided for this purpose. The analog video signal output from the image D/A converting circuit 24 is output via the video signal amplifier circuit 26.

If the shutter-release button 1 is pressed (or while the shutter-release button 1 is being pressed in a moving picture recording mode), the image data output from the image processing and CCD driving circuit 23 as mentioned above is applied to a DRAM & compression/expansion circuit 27, where the image data is stored temporarily. The DRAM & compression/expansion circuit 27 compresses the image data (as by compression in accordance with the JPEG standard).

The compressed image data is applied to and recorded on a memory card 59 under the control of a card & memory controller 30.

Further, image data that has been recorded on the memory card 59 is read by the card & memory controller 30 and input to the DRAM & compression/expansion circuit 27. The latter expands this image data and the image D/A converting circuit 24 converts the expanded image data to an analog video signal. The analog video signal is applied to the liquid crystal display device 13 via the liquid crystal driver 25, whereby the image represented by the image data that has been recorded on the memory card 59 is displayed on the liquid crystal display device 13.

Sound that has entered a microphone 41 is converted to an audio signal and then is amplified by a driver & amplifier circuit 42. The amplified audio signal is converted to digital audio data by an A/D & D/A converting circuit 43. The digital audio data is input to the DRAM & compression/expansion circuit 27 via an audio processing circuit 44. The DRAM & compression/expansion circuit 27 compresses the audio data (as by compression in accordance with the MP3 standard). The compressed audio data is applied to and recorded on the memory card 59 under the control of the card & memory controller 30.

Further, audio data that has been recorded on the memory card 59 is read by the card & memory controller 30 and is expanded by the DRAM & compression/expansion circuit 27. The expanded audio data is converted to an analog audio signal via the audio processing circuit 44. The audio signal obtained by the conversion is amplified by the driver & amplifier circuit 42 and applied to a speaker 45, whence the amplified signal is output as sound.

Headphones can be connected to the digital camera, in which the audio signal output from the audio processing circuit 44 is output as sound from the headphones via a headphone driver 46.

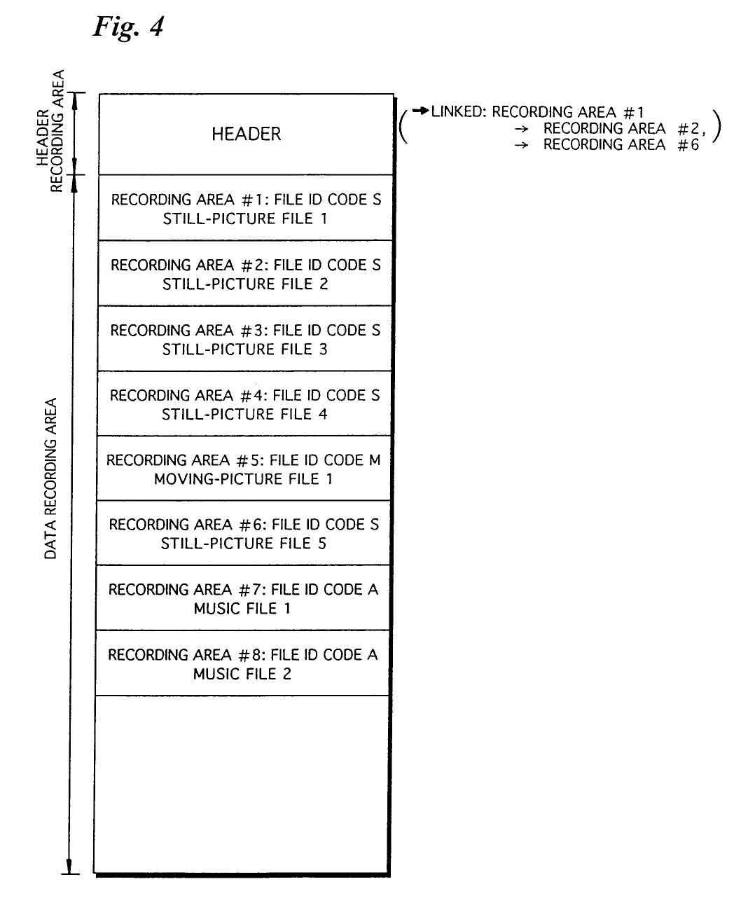

FIG. 4 illustrates the structure of data on the memory card 59.

The memory card 59 includes a header recording area and a data recording area.

As mentioned earlier, a still-picture file (data), moving-picture file and audio file are recorded in the data recording area. The data recording area includes a plurality of recording areas (which, it goes without saying, need not exist physically). Still-picture files have been stored in recording areas #1, #2, #3, #4, #6, and a moving-picture file has been stored in a recording area #5. Audio files have been stored recording areas #7 and #8.

Also recorded in respective ones of these recording areas is identification code data for identifying whether recorded files are still-picture files, a moving-picture file or audio files. Data indicating an identification code “S”, which is indicative of a still picture, has been recorded in the recording areas storing the still-picture files, data indicating an identification code “M”, which is indicative of a moving picture, has been recorded in the recording area storing the moving-picture file, and data indicating an identification code “A”, which is indicative of audio, has been recorded in the recording areas storing the audio files. It goes without saying that these items of identification data are recorded in the data recording area in the corresponding areas based upon the mode set by the mode switch 3.

Management data for managing the memory card 59 has been recorded in the header recording area.

Furthermore, in this embodiment, linkage data also has been recorded in the header recording area in addition to the management data. The linkage data indicates in which recording areas related files have been recorded, wherein the related files are among those that have been recorded in the recording areas. For example, files that are related to the file that has been recorded in recording area #1 are files that have been stored in respective ones of recording areas #2 and #6.

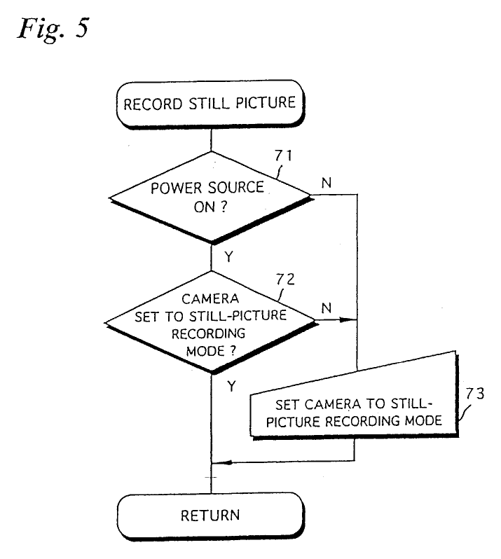

FIG. 5 is a flowchart illustrating processing for setting the still-picture recording mode.

As mentioned above, depending upon the combination of mode switches 2 and 3, recording or playback of a still picture can be set, recording or playback of a moving picture can be set, recording or playback of audio can be set and the power source can be turned off.

When the still-picture recording mode is set, first it is determined whether the power source has been turned on (step 71). If the mode switch 3 has been set to the still-picture mode, moving-picture mode or audio mode, then the power source is on. If the power source is on (“YES” at step 71), then it is determined whether the mode switch 2 has been set to the recording mode and whether the mode switch 3 has been set to the still-picture mode (step 72).

If the power source is not on (“NO” at step 71), or if the power source is on but the still-picture recording mode has been set (“NO” at step 72), then the operator operates the mode switches 2 and 3 so as to set the mode switch 2 to the recording mode and the mode switch 3 to the still-picture mode (step 73). As a result, image data representing the image of a subject sensed in response to pressing of the shutter-release button 1 will be recorded on the memory card 59.

It goes without saying that an arrangement may be adopted in which the still-picture recording mode, still-picture playback mode, moving-picture recording mode, moving-picture playback mode, audio recording mode and audio playback mode can be set by the single mode switch 3. This would make the recording/playback mode switch 2 unnecessary.

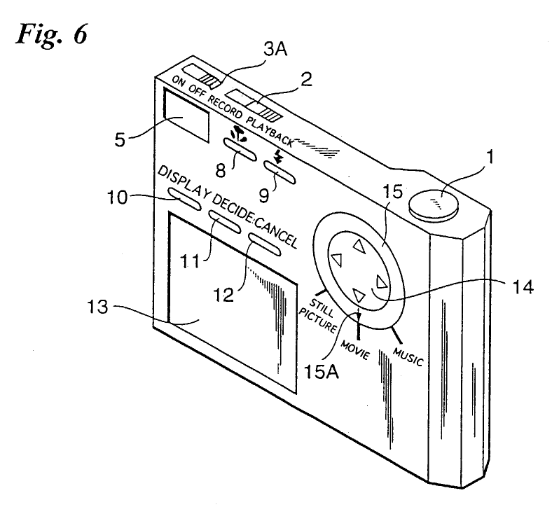

FIG. 6 is a perspective view of a digital camera as seen from the back side thereof. Components in FIG. 6 identical with those shown in FIG. 2 are designated by like reference characters and need not be described again.

Here a power switch 3A is provided on the top of the digital camera on the left side thereof as seen from the back. The power switch 3A turns the power source of the digital camera on and off.

The up, down, left, right button 14 on the back of the digital camera is provided with a freely rotatable mode dial 15. The latter is formed to have an arrow 15A for indicating the mode. Characters representing “STILL PICTURE”, “MOVIE” and “MUSIC” are written on the camera body along the circumference of the mode dial 15. The mode whose characters are pointed to by the arrow 15A of the mode dial 15 becomes the set mode.

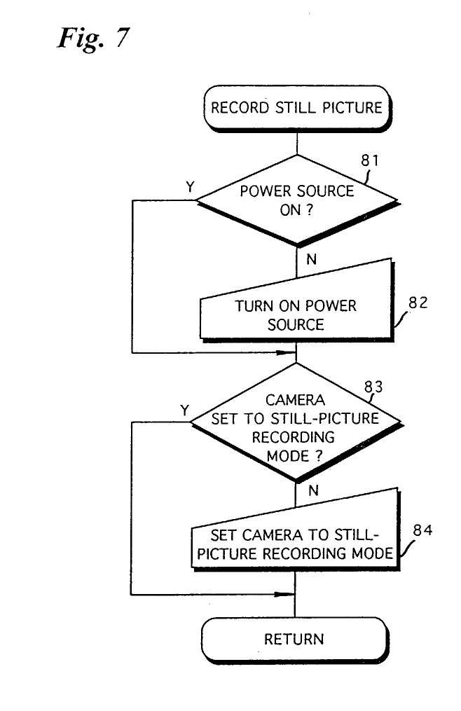

FIG. 7 is a flowchart illustrating processing for when the still-picture recording mode is set on the digital camera shown in FIG. 6.

It is determined whether the power source has been turned on by the power switch 3A (step 81). If the power source has not been turned on (“NO” at step 81), the user operates the power switch 3A to turn on the power source (step 82).

Next, it is determined whether the mode setting switch has been set to the recording mode and whether the mode setting dial 15 has been set to the still-picture mode (step 83). If the recording/playback mode switch 2 has been set to the recording mode and the mode setting dial 15 has been set to the still-picture mode, then the still-picture recording mode will have been established (“YES” at step 83). Otherwise (“NO” at step 83), the operates places the recording/playback mode switch 2 is the recording mode and places the mode setting dial 15 in the still-picture mode to establish the still-picture recording mode (step 84).

If the still-picture recording mode is thus set, image data representing the image of a subject sensed in response to pressing of the shutter-release button 1 will be recorded on the memory card 59.

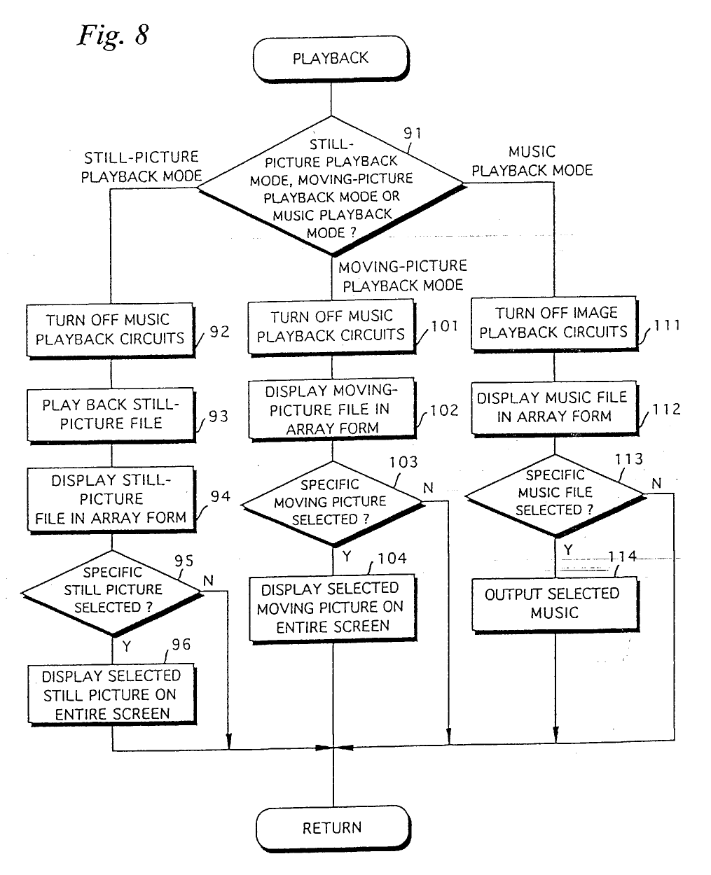

FIG. 8 is a flowchart of playback processing executed by the digital camera shown in FIGS. 1 and 2.

If the playback mode is set by the recording/playback mode switch 2 in the manner described above, it is determined whether the mode of the mode switch 3 has been set to the still-picture mode (still-picture playback mode), moving-picture mode (moving-picture playback mode) or music mode (music playback mode) (step 91).

If the still-picture playback mode is set, the circuits necessary for reproducing a still picture are supplied with voltage from the DC/DC regulator 55. Circuits for music playback, which are not necessary for playing back a still picture, are turned off and supply of voltage thereto is halted (step 92). More specifically, supply of voltage is cut off to the headphone driver 46, driver & amplifier circuit 42 and A/D & D/A converting circuit 43.

From among the files that have been recorded on the memory card 59 inserted into the digital camera, a still-picture file is read out upon referring to the file identification code and then the still picture of this file is reproduced (step 93). That is, a file that has been recorded in a recording area for which the identification code is “S” is read out and reproduced for playback. Image data representing a thumbnail image is produced from the still-picture file played back. It goes without saying that if the still-picture file is accompanied by thumbnail-image data, then processing for making the conversion to the thumbnail-image data will be unnecessary.

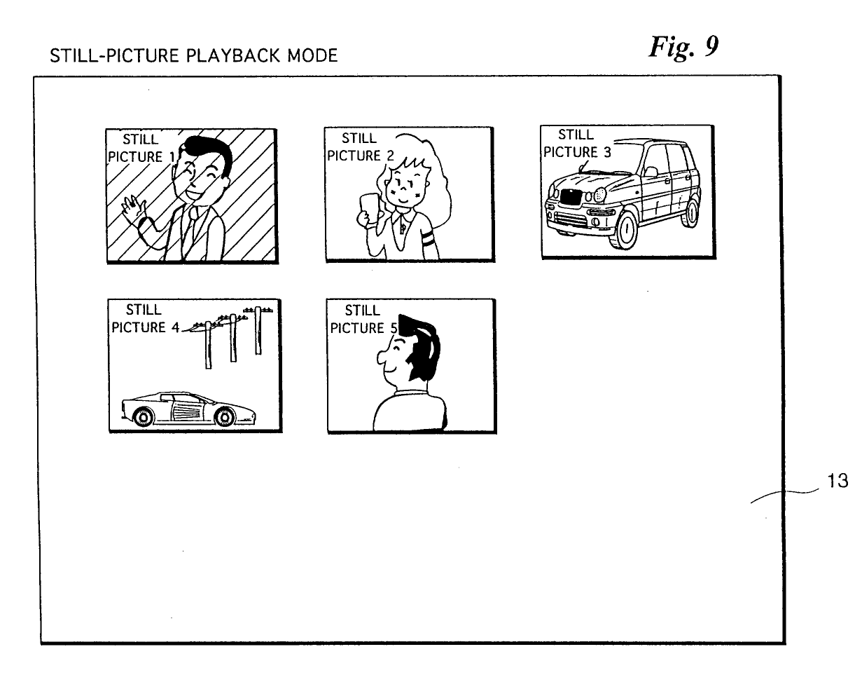

By applying the produced thumbnail-image data to the liquid crystal display device 13, the thumbnail image of the still picture is displayed in an array in the manner shown in FIG. 9 (step 94). Only one thumbnail image (indicated by the hatching in FIG. 9) among the array of displayed thumbnail images appears brightened to distinguish it from the other thumbnail images. The thumbnail image indicated by the hatching is the image that has been selected by the user. By pressing the up, down, left or right arrow formed on the up, down, left, right button 14, the image above, below or to the left or right is brightened. This makes it possible to select another image.

If the decide switch 11 is pressed, the camera regards this as selection of the brightened thumbnail image (“YES” at step 95), the still-picture file corresponding to the selected thumbnail image is read out of the memory card 59 and the still image in the file is played back. The still-picture image data played back is applied to the liquid crystal display device 13, whereby the still picture is displayed on the entire display screen of the liquid crystal display device 13 (step 96).

If the moving-picture playback mode is selected (step 91), the circuits for music playback are turned off just as in the case of the still-picture playback mode (step 101). Further, the moving-picture file is read out of the memory card 59 and an image representing this moving-picture file is displayed in an array on the display screen of the liquid crystal display device 13 (step 102). If the moving-picture file is selected in the same manner as a still picture (“YES” at step 103), the moving picture represented by the selected moving-picture file is displayed on the entire display screen of the liquid crystal display device 13 (step 104).

If the music playback mode is selected (step 91), the circuits for image playback are turned off. More specifically, the liquid crystal driver 25, liquid crystal display device 13, backlight 58 for the liquid crystal display device, inverter 56 and signal amplifier circuit 26 are turned off. Further, the CDS & A/D converter 22 and CCD driver 31, which are circuits associated with the image recording, may be turned off.

A music file is read out of the memory card 59 upon referring to the identification code. An image indicative of the music file read out is displayed in an array on the display screen of the liquid crystal display device 13 (step 112). The music file is selected by the user in the same way that still pictures and moving pictures are selected (step 113). The selected music file is read out of the memory card 59. As a result, music is output from the speaker 45 or headphones (step 114).

In the playback processing described above, the user selects the desired playback mode from among the still-picture, moving-picture and music playback modes and the corresponding file is read out of the memory card. However, rather than selecting the playback mode, a file can be selected first and playback can be performed in the mode that corresponds to the selected file. Such playback processing will be described next.

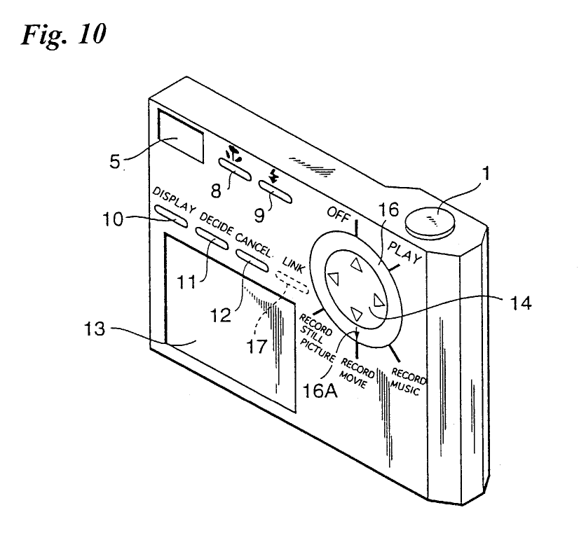

FIG. 10 is a perspective view of a digital camera as seen from the back side thereof. Components in FIG. 10 identical with those shown in FIG. 2 are designated by like reference characters and need not be described again.

The up, down, left, right button 14 is provided with a freely rotatable mode dial 16 on which an arrow 16A is formed. Characters representing “RECORD STILL PICTURE”, “RECORD MOVIE”, “RECORD MUSIC”, “PLAYBACK” and “OFF” are written on the camera body along the circumference of the mode dial 16.

The mode among the modes “RECORD STILL PICTURE”, “RECORD MOVIE”, “RECORD MUSIC”, “PLAYBACK” and “OFF” whose characters are pointed to by the arrow 16A of the mode dial 16 becomes the set mode.

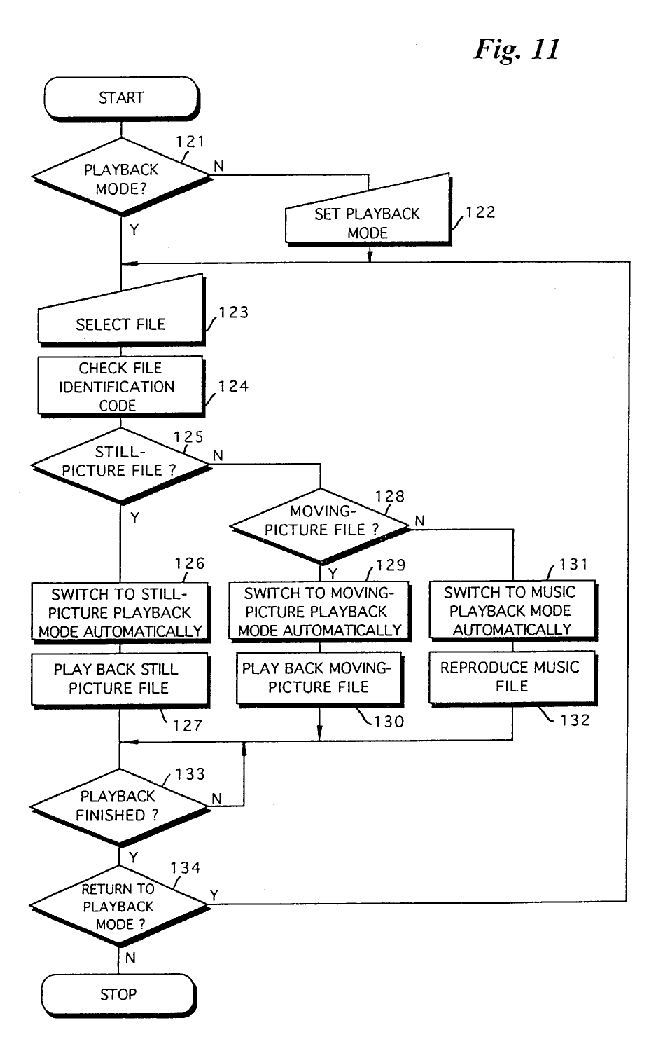

FIG. 11 is a flowchart illustrating processing executed by the digital camera when “PLAYBACK” has been designated by the arrow 16A of mode dial 16.

It is determined whether the playback mode has been set (step 121). If the playback mode has not been set (“NO” at step 121), the user turns the mode dial 16 to set the playback mode (step 122).

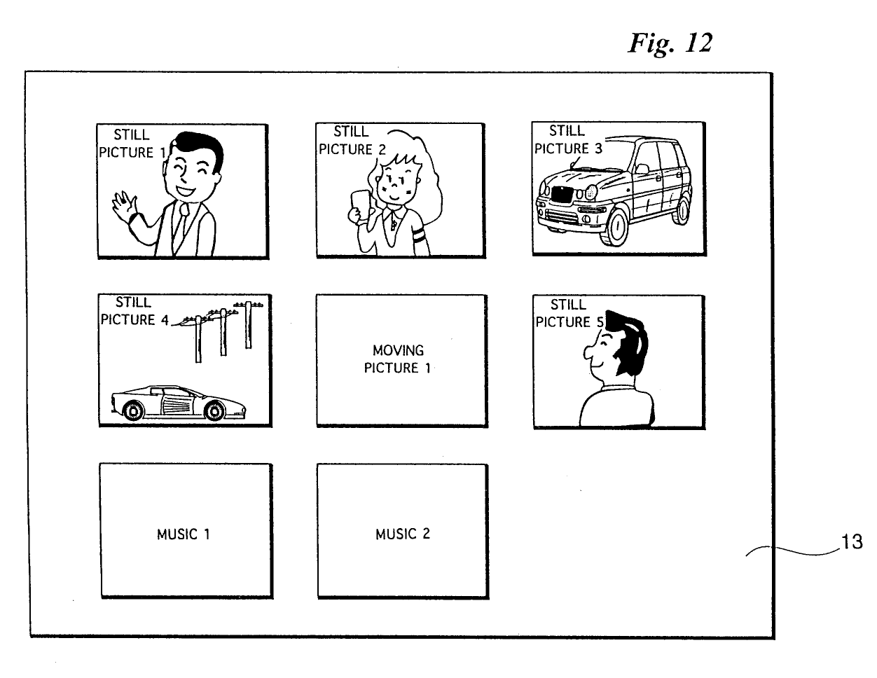

If the playback mode is set, images representing all of the files that have been recorded on the memory card 59 are displayed in an array on the display screen of the liquid crystal display device 13 (see FIG. 12). It goes without saying that the thumbnail size reduction processing would be executed as necessary with regard to still-picture files as necessary.

Using the up, down, left, right button 14 in the manner described above, the user selects a desired image from among the images displayed on the display screen of the liquid crystal display device 13 (step 123). The file corresponding to the selected image (a still-picture file, moving-picture file or music file) is read out of the memory card 59. The data representing the identification code of the read file is checked (step 124).

If it is found as a result of the checking of the identification data that the selected image is a still picture (“YES” at step 125), then the above-described still-picture playback mode is established (step 126). As a result, the circuits for music playback are turned off. The still-picture file read out is played back (step 127) and the selected still picture is displayed on the entire display screen of the liquid crystal display device 13.

If it is found as a result of the checking of the identification data that the selected image is a moving picture (“NO” at step 125, “YES” at step 128), then the above-described moving-picture mode is established (step 129). The circuits for music playback are turned off just as in the still-picture playback mode. The moving-picture file that has been read out is played back (step 130) and the selected moving picture is displayed on the entire display screen of the liquid crystal display device 13.

If it is found as a result of the checking of the identification data that what the selected image represents is music (“NO” at step 128), then the above-described music playback mode is established (step 131). The music file that has been read out is played back (step 132) and music is output from the speaker 45 or headphones.

When playback of the selected file ends (“YES” at step 133), it is determined whether control should return to the playback mode (text calling for confirmation would be displayed on the display screen of the liquid crystal display device 13). If control is to be returned to the playback mode (“YES” at step 134), then the user presses the decide button 11, by way of example. As a result, images would be displayed again in an array on the display screen of the liquid crystal display device 13 in the manner shown in FIG. 12. If control is not to return to the playback mode (“NO” at step 134), then the user turns the mode dial 16 to set another mode or to turn the camera off.

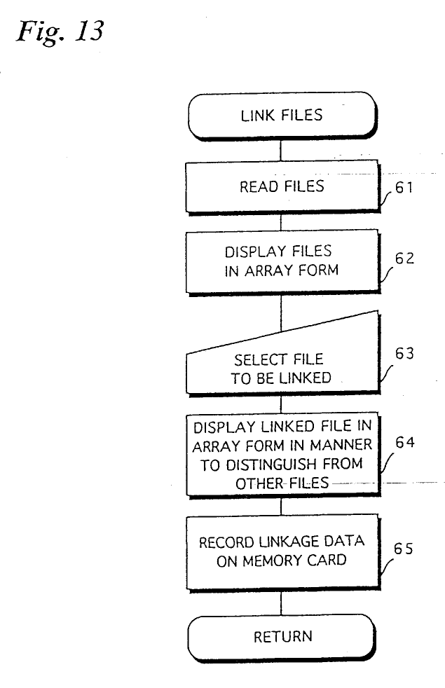

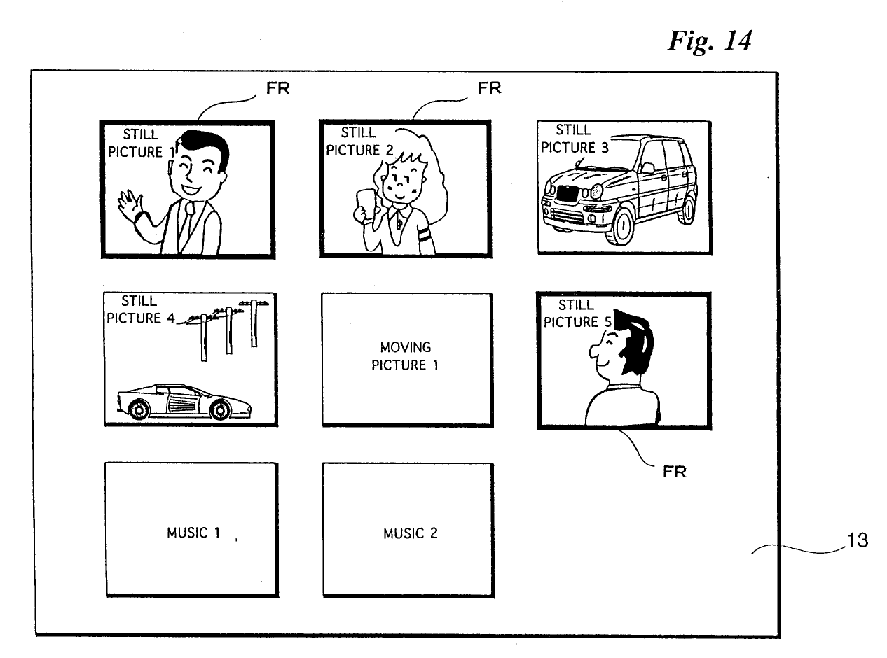

FIG. 13 is a flowchart illustrating processing for linking files that have been recorded on the memory card 59, and FIG. 14 shows an example of a display presented on the liquid crystal display device 13 of the digital camera.

When the digital camera has a function for linking files, the digital camera shown in FIG. 10 is provided with a linking button 17.

The digital camera is set to the playback mode, files that have been recorded on the memory card 59 inserted into the digital camera are read out (step 61) and the images indicated by these files are displayed in an array on the display screen of the liquid crystal display device 13 (step 62), as shown in FIG. 12.

The user presses the linking button 17 and uses the up, down, left, right button 14 to select an image representing a file that is to be linked with other files (step 63). If the user presses the decide button 11 in a state in which an image has thus been selected, a frame FR is formed about the selected image (step 64). The processing of steps 63 and 64 is repeated for all images indicating files that are to be linked. Pressing the decide button 11 terminates the image linkage processing.

Data indicating the linkage among the images is recorded in the header recording area of the inserted memory card (see FIG. 4) (step 65).

Data indicating the linkage is thus recorded on the memory card 59. When images representing files are displayed in an array on the display screen of the liquid crystal display device 13 at playback of the memory card 59, the-frames FR are displayed surrounding the linked images, as shown in FIG. 14. In a case where the memory card 59 contains linked-image groups of two or more kinds and these groups of images are unrelated, the images constituting one image group of linked images would be surrounded by single frames and the images constituting the other image group would be surrounded by double frames to distinguished the groups from each other.

An arrangement may be adopted in which when a music file and either a moving-picture file or still-picture file linked with the music file have been selected as files for playback, the output of audio represented by the linked music file, the display of a moving picture represented by the moving-picture file or the display of the still picture represented by the still-picture file are performed simultaneously. In such case, rather than some of the circuits being turned off in accordance with the mode, as described above, all circuits would be turned on.

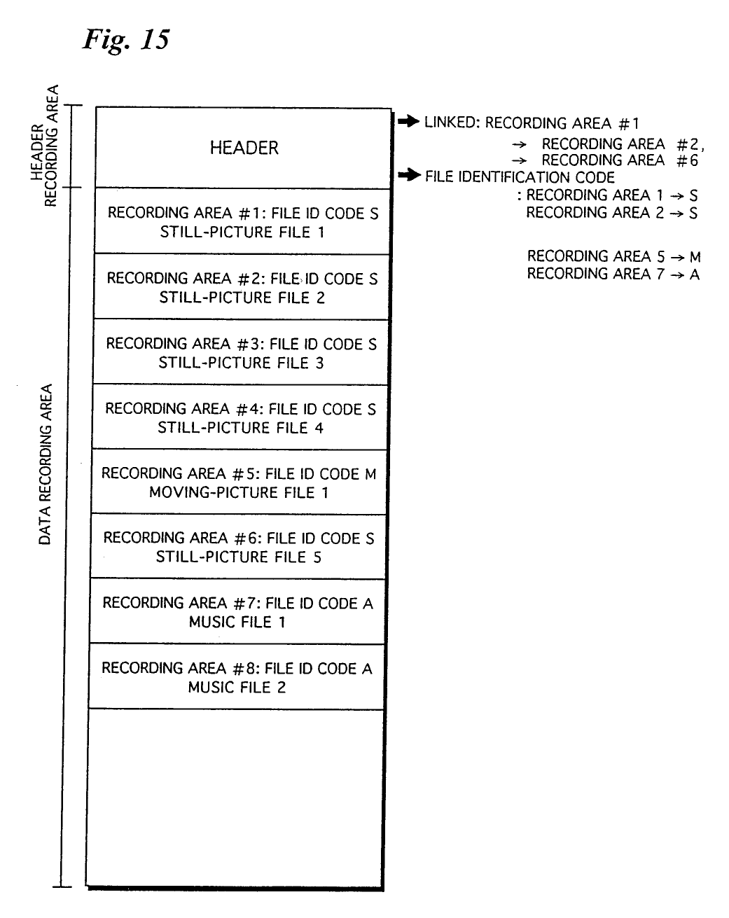

FIG. 15 illustrates an example of the structure of data on a memory card. Whereas the data structure of the memory card shown in FIG. 4 is such that file identification data is recorded in each of the recording areas, the file identification data shown in FIG. 15 is recorded in the header recording area.

Thus, an arrangement may be adopted in which file identification data is recorded in the header recording area even if it is not recorded in association with each recording area of the data recording area.

As many apparently widely different embodiments of the present invention can be made without departing from the spirit and scope thereof, it is to be understood that the invention is not limited to the specific embodiments thereof except as defined in the appended claims.

What is claimed is:

1. A portable image playback apparatus comprising:
a data reading unit for reading data that has been recorded on a recording medium capable of recording both image data representing an image and audio data representing audio;
an image playback processing unit for subjecting image data, which has been read by said data reading unit, to image playback processing;
a first display controller for controlling a display unit so as to display an image represented by the image data that has been subjected to image playback processing by said image playback processing unit;
an audio playback processing unit for subjecting audio data, which has been read by said data reading unit, to audio playback processing; and
an audio output unit for outputting audio, which is represented by the audio data that has been subjected to audio playback processing by said audio playback processing unit, independently of display of an image on the display unit.

2. The apparatus according to claim 1, further comprising a data determination unit for determining whether data that has been read by said data reading unit is image data or audio data;
wherein in accordance with a determination that the data that has been read from the recording medium is image data, said image playback processing unit subjects the read image data to image playback processing; and
in accordance with a determination that the data that has been read from the recording medium is audio data, said audio playback processing unit subjects the read audio data to audio playback processing.

3. The apparatus according to claim 2, further comprising a mode setting unit for selectively setting either an image playback mode or an audio playback mode;
wherein said data determination unit determines whether data that has been read by said data reading unit is image data or audio data in accordance with the mode that has been set by said mode setting unit.

4. The apparatus according to claim 2, wherein image identification data is linked with the image data in order to identify that this data is image data, and audio identification data is linked with the audio data in order to identify that this data is audio data; and
said data determination unit determines whether data that has been read is image data or audio data based upon the image identification data or the audio identification data.

5. The apparatus according to claim 2, wherein the recording medium includes a header recording area and a data recording area, the image data and the audio data have been recorded in the data recording area, and identification data indicating whether data that has been recorded in a prescribed area of the data recording area is image data or audio data has been recorded in the header recording area; and
said data determination unit determines whether data that has been read is image data or audio data based upon the identification data that has been recorded in the header recording area.

6. The apparatus according to claim 1, further comprising:
an image sensing unit for sensing the image of a subject and outputting image data representing the image of the subject; and
a recording controller for recording image data, which has been output from said image sensing unit, on the recording medium.

7. The apparatus according to claim 1, further comprising:
a mode command switch for selectively applying an image playback mode command or an audio playback mode command; and
a power-source controller for turning on a power source in response to application of the image playback mode command or audio playback mode command by said mode command switch.

8. The apparatus according to claim 1, further comprising:
a power switch;
a power-source control unit for turning on a power source in response to said power switch being turned on;
a mode command switch for selectively applying an image playback mode command or an audio playback mode command; and
a power supply unit for starting supply of power to said image playback processing unit and to said first display controller in accordance with application of the image playback mode command by said mode command switch, and starting supply of power to said audio playback processing unit and to said audio output unit in accordance with application of the audio playback mode command by said mode command switch.

9. The apparatus according to claim 1, further comprising:
a mode setting unit for selectively setting the image playback mode or the audio playback mode; and
a second display controller for controlling the display unit so as to display the name of a file storing data corresponding to the mode that has been set by said mode setting unit, said data being part of the data that has been read by said data reading unit.

10. The apparatus according to claim 1, further comprising:
a determination unit for determining whether image data and audio data that have been read by said data reading unit are linked to each other; and
a unit for controlling said first display controller and said audio output unit, in accordance with a determination by said determination unit that the image data and audio data have been linked to each other, in such a manner that audio represented by read audio data is output during display of an image represented by read image data.

11. The apparatus according to claim 1, further comprising:
a data detection unit for detecting mutually linked image data and audio data in data that has been read by said data reading unit; and
a third display controller for controlling the display unit in such a manner that the names of files storing data detected by said data detection unit will be displayed in a manner distinguishable from the names of other files.

12. The apparatus according to claim 1, further comprising:
a fourth display controller for controlling the display unit so as to display images represented by image data that has been read by said data reading unit; and
an image display control unit for displaying, in a form distinguishable from other images, an image represented by image data, which is linked with other image data or with audio data, contained in image data representing an array of displayed images.

13. The apparatus according to claim 12, further comprising a device for controlling said fourth display controller or said audio output unit, in accordance with selection of an image represented by the image data linked with the other image data or with the audio data, so as to display an image or output audio represented by the other image data or by the audio data that is linked with said image data.

14. A portable image pick-up apparatus comprising:
an image sensing unit for sensing the image of a subject and outputting image data representing the image of the subject;
an audio-data input unit for inputting audio data;
a selection unit for selecting, from image data output by said image sensing unit and audio data input by said audio-data input unit, image data and audio data to be linked with each other; and
a recording controller for recording the image data and the audio data selected by said selection unit on a recording medium in a form linked with each other.

15. A method of controlling operation of a portable image pick-up apparatus comprising the steps of:
reading data that has been recorded on a recording medium capable of recording both image data representing an image and audio data representing audio;
subjecting read image data to image playback processing;
displaying on a display unit an image represented by the image data that has been subjected to image playback processing;
subjecting read audio data to audio playback processing; and
outputting audio, which is represented by the audio data that has been subjected to audio playback processing, independently of display of an image on the display unit.

16. A method of controlling operation of a portable image playback apparatus comprising the steps of:
sensing the image of a subject and obtaining image data representing the image of the subject;
inputting audio data;
selecting, from image data that has been obtained by image sensing and audio data that has been input, image data and audio data to be linked with each other; and
recording the selected image data and audio data on a recording medium in a form linked with each other.
